(19) United States
(12) Patent Application Publication
(10) Pub. No.: US 2011/0188347 A1
(43) Pub. Date: Aug. 4, 2011

(54) VOLUME IMAGING FOR HYDRAULIC FRACTURE CHARACTERIZATION

(75) Inventors: Marc Thiercelin, Dallas, TX (US); Joel Le Calvez, Farmers Branch, TX (US); Javaid Durrani, Dallas, TX (US); Mark McCallum, Cypress, TX (US); Bruce P. Marion, Houston, TX (US); Luke Wilkens, Houston, TX (US); Gisele Thiercelin, Dallas, TX (US)

(73) Assignee: SCHLUMBERGER TECHNOLOGY CORPORATION, Cambridge, MA (US)

(21) Appl. No.: 12/851,261

(22) Filed: Aug. 5, 2010

Related U.S. Application Data
(60) Provisional application No. 61/299,847, filed on Jan. 29, 2010.

(51) Int. Cl. G01V 1/00

(52) U.S. Cl. 367/38; 367/69

(57) ABSTRACT

Methods and systems are described for measuring effects of a hydraulic fracturing process. The techniques can utilizes cross-well seismic technology, such as used in Schlumberger's DeepLook-CS tools and service, or in some case surface to borehole or borehole to surface seismic technology. The downhole seismic sources at known locations can be conventional sources or can be other types of equipment operating at known locations such as perforation guns. The source is activated or swept creating energy which is transmitted through the formation. The energy is recorded at the receiver array and processed to yield a tomographic image indicating changes in the subterranean formation resulting from the hydraulic fracturing process. The process can be performed pre and post hydraulic fracture stimulation to generate a difference image of propped fractures in the reservoir.

### CROSS-REFERENCE TO RELATED APPLICATION

This patent application claims the benefit of U.S. Ser. No. 61/299,847, filed Jan. 29, 2010, which is incorporated by reference herein.

### BACKGROUND

1. Field

This patent specification relates generally to hydraulic fracturing characterization in wellbore applications. More particularly, this patent specification relates to three-dimensional imaging for hydraulic fracture characterization.

2. Background

Hydraulic fracturing for stimulation of conventional reservoirs consists of the injection of a high viscosity fracturing fluid at high flow rate to open and then propagate a bi-wing tensile fracture in the formation. With the exception of the near-wellbore region where a complex state of stress might develop, it is expected that this fracture will propagate normal to the far-field least compressive stress. The length of this tensile fracture can attain several hundred meters during a fracturing treatment of several hours. The fracturing fluid contains proppants, which are well-sorted small particles which are added to the fluid to maintain the fracture open once the pumping is stopped and pressure is released. This allows one to create a high conductivity drain in the formation. Examples of these particles includes sand grains and ceramic grains. At the end of the treatment, it is expected to obtain a fracture fully packed with proppants. The production of the hydrocarbons will then occur through the proppant pack. The hydraulic conductivity of the fracture is given by the proppant pack permeability and the retained fracture width.

Hydraulic fracturing is also very successfully applied in very low permeability gas saturated formations (often called unconventional gas reservoirs). These formations include tight-gas sandstones, coal bed methane, and gas shales. While the permeability of tight-gas sandstones is of the order of hundreds of microDarcy, gas shale permeability is of the order of hundreds of nanoDarcies. These reservoirs cannot be produced without stimulation. In these formations, field observations of fracturing treatment do not always support the concept of the creation of the commonly accepted bi-wing tensile fracture. Mine-back experiments (see, Warpinski, N. R. and Teufel, L. W. (1987) Influence of geologic discontinuities on hydraulic fracture propagation, Journal of Petroleum Technology, 39, 2, Aug. 1987: 209-220; Jeffrey, R. G., Byrnes, R. P., Lynch, P. A. and Ling, D. J. (1992) An Analysis of Hydraulic Fracture and Mineback Data for a Treatment in the German Creek Coal Seam, Paper SPE 24362, In Proceedings of the 1992 SPE Rocky Mountain. Regional Meeting, Casper, Wyo., USA, 18-21 May 1992: 445-457 (hereinafter “Jeffrey 1992”); and Jeffrey, R. G., Weber, C. R., Vlahovic, W. and Enever, J. R. (1994) Hydraulic Fracturing Experiments in the Great Northern Coal Seam, Paper SPE 28779, In Proceedings of the 1994 SPE Asia Pacific Oil and Gas Conference, Melbourne, Australia, 7-10 Nov. 1994: 361-371), information obtained from laterals drilled across previously hydraulically fractured zones (see, Warpinski, N. R., Lorenz, J. C., Branagan, P. T., Myal, F. R. and Gall, B. L (1993) Examination of a Cored Hydraulic Fracture in a Deep Gas Well., SPE Production and Facilities, 8, 3, Aug. 1993: 150-158; and Waters, GT., Heinze, J., Jackson, R., Ketter, A. Daniels, J. and Bentley, D. (2006) Use of Horizontal Well Image Tools to Optimize Barnett Shale, In Proceedings of Reservoir Exploitation SPE Annual Technical Conference and Exhibition, San Antonio, Tex., USA, 24-27 Sep. 2006), and the record of microseismic events during a stimulation treatment (see, Fisher, M. K., Wright, C. A., Davidson, B. M., Goodwin, A. K, Fielder, E. O. Buckler, W. S. and Steinsberger, N. P. (2005) Integrating Fracture-Mapping Technologies To Improve Stimulations in the Barnett Shale, SPE Production and Facilities, 20, 2, May 2005: 85-93; and Daniels, J., Waters, G., Le Calvez, J., Lassek, J. and Bentley, D. (2007) Contacting More of the Barnett Shale Through an Integration of Real-Time Microseismic Monitoring, Petrophysics, and Hydraulic Fracture Design, In Proceedings of SPE Annual Technical Conference and Exhibition, Anaheim, Calif., U.S.A, 11-14 Nov. 2007 (hereinafter “Daniels 2007”)) indicate the creation of a complex fracture network geometry. The actual cause of this complex pattern is not yet fully established, but the above mine-back experiments, including those done for mining application (see, Van As, A. and Jeffrey, R. G. (2000) Caving induced by hydraulic fracturing at Northparkes Mines. In Proceedings of the 4th North American Rock Mechanics Symposium, Pacific Rocks 2000 Seattle, Wash. Jul. 31-Aug. 3, 2000, J. Girard, and others, (Eds), 353-360. Rotterdam: Balkema), and field observations of natural hydraulic fractures (see, e.g. Pollard, D. D. and Aydin, A. (1988) Progress in understanding joints over the last century, Geological Society of American Bulletin, 100: 1181-1204; and Cooke, M. L. and Underwood, C. A. (2000) Fracture termination and step-over at bedding interfaces due to frictional slip and interface opening, Journal of Structural Geology, 23: 223-238) suggest that natural fractures prevent the creation of a single tensile fracture and promote the creation of fracture offsets and multi-branched fractures. This is especially true in some shales where tensile natural fractures are not aligned with the current principal stress direction because they were created in an era where the stress directions were different. It is still assumed that the majority of the newly induced fractures propagate normal to the far-field least compressive stress, creating the so-called fracture “fairway”, though shear fractures, mainly through the reactivation of pre-existing discontinuities, bedding planes and natural faults are expected.

Complex fracture patterns have significant consequences for the design of the fracturing treatment. See, Jeffrey 1992; Medlin, W. L. and Fitch, J. L. (1988) Abnormal treating pressures in MHF treatments, Journal of Petroleum Technology, May 1988: 633-642; Daneshy, A. (2003) Off-balance growth: A new concept in hydraulic fracturing, Journal of Petroleum Technology, 55, 4, Apr. 2003: 78-85; and Zhang, X. and Jeffrey, R. G. (2006) The role of friction and secondary flaws on deflection and re-initiation of hydraulic fractures at orthogonal pre-existing fractures, Geophysical Journal International, 166: 1454-1465. The fracture width of each branch of this complex fracture network is smaller than that of a single fracture, and the conventionally used proppant might not be able to be transported to the entire length of the fracture network.

Shear displacement along pre-existing discontinuities or even induced shear fractures might occur, which in turn, due to dilatancy effects, will increase the fracture conductivity without the need for the fracture to be fully propped. Finally, the pressure response during the treatment might be very different from that of a bi-wing fracture

The current approach to estimate the production following the stimulation treatment in a complex reservoir where a fracture fairway has been created is to assume that the stimulation has created an enhanced permeability zone of about the size the microseismicity cloud, the so-called ESV estimated stimulated zone (see, Daniels 2007). The ESV is defined as the reservoir volume which has been contacted by the stimulation treatment as determined by the microseismic event location and density. However, it is not necessarily linked to the enhanced permeability zone. The actual conductive zone is probably much smaller that the ESV because the proppant was not transported very far from the wellbore. Fracture complexity creates pinch points which restrict proppant transport. Use of low viscosity fluid with poor transport properties compounds the problem of poor proppant placement. It is also not clear whether unpropped fracture can be conductive, especially if the amount of shear along the fracture plane is limited. Consequently the obtained production estimated on the ESV is not based on sound measurement of a conductive zone. Ways to properly evaluate the efficiency of the stimulation treatment are lacking and consequently may not be optimized.

There is therefore a need to develop a technique which provides some estimate of the fractured zone which was propped, or at least retained some conductivity.

Various techniques have been developed to estimate the geometry of created fractures. One commonly used technique when the fracture is bi-wing is an indirect evaluation based on the analysis of the pressure response measured during the treatment and the production. This analysis provides very general information about fracture length, fracture conductivity and fracture width when the fracture is bi-wing but fails when a fracture network is created. Moreover, it suffers a lack of uniqueness and therefore does not provide much information about the exact fracture geometry. Production analysis provides information about the effective length of the fracture and its apparent conductivity but cannot give details about the actual three-dimensional nature of fracture conductivities. Its prediction is also non unique.

More reliable are acoustic fracture imaging methods based on event location using passive acoustic emission. See, Barree, M. K. Fisher, R. A. Woodroof, “A practical guide to hydraulic fracture diagnostic technologies”, paper SPE 77442, presented at the SPE Annual Technical Conference and Exhibition held in San Antonio, Tex., USA, 28 September-2 October 2002 (hereinafter “Barree 2002”). The acoustic emissions which are recorded during hydraulic fracturing are micro-earthquakes which are generated in the vicinity of the fracture and are caused either by the stress change generated around the fracture or by the decrease of effective stress around the fracture following fracturing fluid leak-off into the formation. In some cases, the events are analyzed to provide some information about the source parameters (energy, displacement field, stress drop, source size, etc.) and when possible, about the source mechanisms. These events are recorded by an array of geophones or accelerometers placed in adjacent boreholes. They never provide direct quantitative information on the main fractures. This technology is common practice in the field and is especially suited to estimate fracture azimuth, dip and complexity. One disadvantage of this technique is that micro-earthquakes occur around the fractures and provide a cloud of events, which does not allow a precise determination of fracture geometry. As mentioned above, recent attempts concern the use of the estimated stimulation volume (ESV) for production estimation assuming that the cloud of microseismic events represents the zone which has been successfully stimulated and remain conductive once the fractures have been closed. But there is not guarantee that the stimulated volume matches the conductive volume. Current studies indicate a two order of magnitude mismatch in term of created surface area because the conductive zone has a much lower extent than the stimulated zone.

Yet another technique of hydraulic fracture evaluation is tiltmeter mapping. See, Barree 2002. This technique comprises monitoring of a deformation pattern of the rock surrounding the induced fracture network. An array of tiltmeters measures the gradient of the displacement (tilt) field versus time. The induced deformation field is primarily a function of fracture azimuth, dip, depth to fracture middle point and total fracture volume. The shape of the induced deformation field is almost completely independent of reservoir mechanical properties if the rock is homogeneous. Surface tiltmeters cannot accurately resolve fracture length and height when the distance between the surface and the fracture is large compared to the fracture dimensions. Downhole tiltmeters placed in the treatment borehole can provide better information on fracture height but they still cannot resolve for fracture length and fracture conductivity. Therefore this technique has some use in shallow reservoir but provides little information in deep reservoirs.

Various authors have worked on the refraction and transmission of waves through natural faults. See, e.g. G. G. Kocharyan, V. N. Kostyuchenko, D. V. Pavlov, “The structure of various scale natural rock discontinuities and their deformation properties. Preliminary results,” Int. J. Rock Mech. & Min. Sci. 34; 3-4, paper 159, 1997. These waves are either initiated from earthquakes or are produced downhole thanks to a seismic source (active acoustic emission). From the attenuation of waves due to fault crossing, one is able to estimate the fault shear and normal stiffness. Similarly, tomography is being used in the laboratory to determine the position of the fracture from refraction and reflection analysis, and again the attenuation can be used to estimate the fracture width. See, Groenenboom, J., vam Dam, D. B. and de Pater, C. J.: “Time-Lapse Ultrasonic Measurements of Laboratory Hydraulic-Fracture Growth: Tip Behavior and Width Profile”, SPE Journal, Vol. 6, No. 3, September 2001, 334-342 (hereinafer “Groenenboom 2001”).

### SUMMARY

According to some embodiments a method of measuring effects of a hydraulic fracturing process on a subterranean formation surrounding a borehole is provided. The method includes deploying and activating one or more sources of acoustic energy and one or more seismic receivers at known locations at least one of which is downhole so as to provide a plurality of ray-paths between source and receiver pairs traversing portions of the subterranean formation in the vicinity of the borehole. Data measured from the one or more sources by the one or more receivers is processed so as to generate three-dimensional data indicating changes in the subterranean formation resulting from the hydraulic fracturing process. According to some embodiments, the sources of acoustic energy are perforation guns or downhole seismic sources. According to some embodiments the sources and receivers are activated prior to the fracturing process and activated again following the fracturing process. The three-dimensional data can be for example, a three dimensional mapped volume image indicating fracture network conductivity. The mapped volume can be constrained by calibrating the mapped volume to surface seismic data and/or shallow borehole seismic data.

According to some embodiments, the processing includes using changes in sonic velocity, changes in P and S wave velocity, using P to S wave conversions, changes in attenuation, and/or changes in frequency content in generating the three-dimensional data. The sources and/or receivers can be deployed in a well adjacent to the treatment well. According to some embodiments at least one of receivers or sources are deployed in the treatment well. According to some embodiments, the seismic receivers are permanently or semi-permanently deployed in a borehole. According to some embodiments, the processing includes use of sonic logging data relating to the subterranean formation in generating the three-dimensional data.

According to some embodiments a system for measuring the effects of a hydraulic fracturing process on a subterranean formation surrounding a borehole is also provided.

As used herein the term “tomography” refers generally to three-dimensional and/or volume imaging.

As used herein the term “seismic” refers generally to acoustic energy capable of travelling through subterranean formation, and includes conventional low-frequency seismic energy as well as micro-seismic energy.

Further features and advantages will become more readily apparent from the following detailed description when taken in conjunction with the accompanying drawings.

### BRIEF DESCRIPTION OF THE DRAWINGS

The present disclosure is further described in the detailed description which follows, in reference to the noted plurality of drawings by way of non-limiting examples of exemplary embodiments, in which like reference numerals represent similar parts throughout the several views of the drawings, and wherein:

FIGS. 1A-B illustrate a configuration for tomographic imaging for hydraulic fracture characterization, according to some embodiments;

FIGS. 2A-C illustrate a configuration for tomographic imaging for hydraulic fracture characterization using downhole seismic sources, according to some embodiments;

FIGS. 3A-B illustrate a configuration for tomographic imaging for hydraulic fracture characterization using downhole or surface seismic sources, according to some embodiments; and

FIG. 4 is a flowchart illustrating processing steps involved according to some embodiments.

### DETAILED DESCRIPTION OF THE PREFERRED EMBODIMENTS

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, systems, processes, and other elements in the invention may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but could have additional steps not discussed or included in a figure. Furthermore, not all operations in any particularly described process may occur in all embodiments. A process may correspond to a method, a function, a procedure, a subroutine, a subprogram, etc. When a process corresponds to a function, its termination corresponds to a return of the function to the calling function or the main function.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

According to some embodiments, a method is provided that allows one to access a conductivity image once the treatment is completed based on microseismic tomography using tools and calibration methods developed for the monitoring and interpretation of microseismic events generated during the stimulation treatment. According to some embodiments, surface seismic (and/or shallow borehole data) data is used, if available, to refine the size of the propped reservoir.

According to some embodiments, a calibration process such as used in microseismicity analysis is used to perform microseismic tomography which is then used to construct a map of fracture network conductivity. According to some embodiments this mapped volume is constrained by calibrating it to surface (and/or shallow borehole) seismic data, if such data are available. Microseismic tomography is particularly suitable in gas shale reservoirs where the distance between lateral wells is small (less than 500 ft), either by using an active seismic source, the waves emitted during perforation, or when feasible, acoustic emission events. According to some embodiments, the tomography could use changes in P and S wave velocity or any other wave attributes, such as attenuation. According to some embodiments, the method is used in vertical wells in cases where the well density is suitably high. According to some embodiments, surface seismic data are used to provide spatially varying 3-D information about P-wave velocity, S-wave velocity (if PS data are available) and anisotropy parameters. This information can be used to refine the ESV. This is in contrast to current practice in which a 1-D velocity and anisotropy model is used in microseismic mapping. According to some embodiments the azimuthal variation of amplitude as a function of angle of incidence is used to estimate fracture orientation, fracture density and the nature of fluid in the fracture. See, Bakulin, A., Grechka, V. and Tsvankin I. (2000), Estimation of fracture parameters from reflection seismic data. Parts I, II, III. Geophysics, 65, 1788-1830. Ideally, we would like to acquire surface seismic data before and after a fracturing job.

According to some embodiments, cross-well tomography with various spatial placement of source and receiver is used to study the effects of fractures on P and S wave velocity and attenuation. If the source is strong enough and the surface (and/or shallow borehole) receivers sensitive enough, these surface (and/or shallow borehole) receivers can be used as well.

As mentioned above, most of shale gas completions consist of drilling a lateral in the direction of the minimum principal stress, separating the lateral in several stages, and for each stage, starting from the toe, perforating using 2-4 perforation clusters then stimulating. Due to the small size of the drainage area the distance between laterals is very small, sometimes of the order of 250 feet.

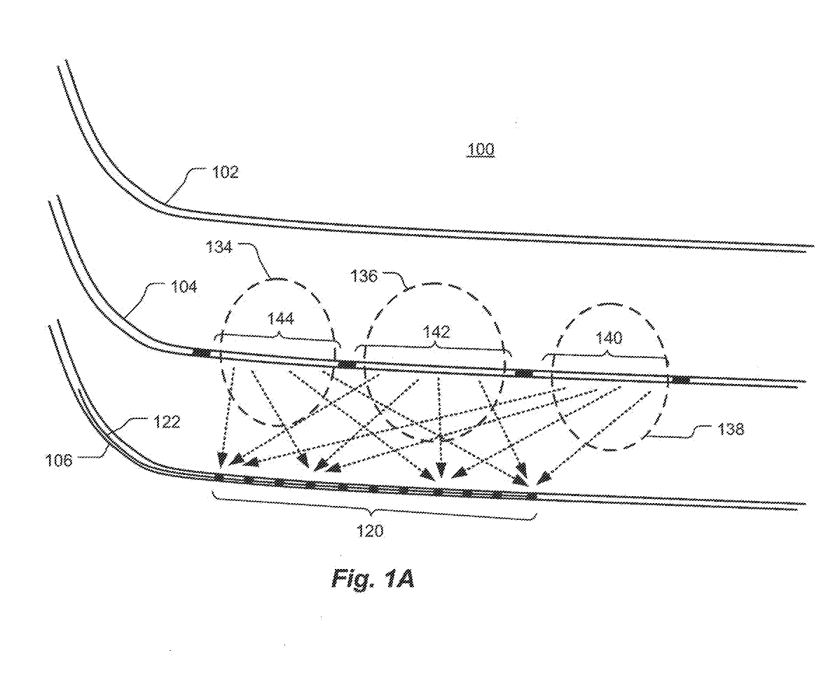

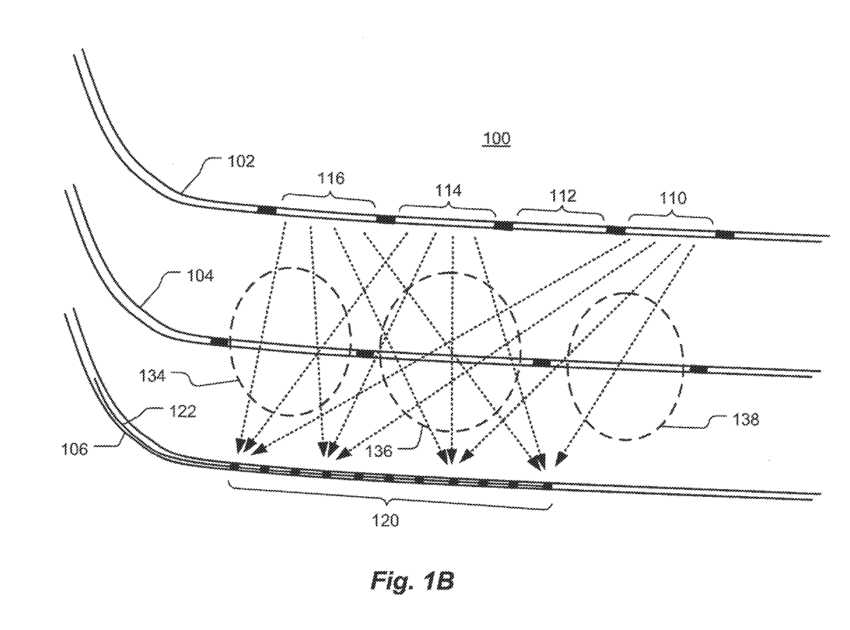

Each treatment is often monitored using the recording of microseismic events, which are micro-earthquakes related to local failure of the rock, associated with the creation of the hydraulically-induced fracture network. One well or one lateral is used as a monitoring well where a monitoring tool is placed. This tool is composed of several shuttles separated by a distance of about 100 feet, and each shuttle contains at least one three-component receiver. The number of shuttles currently ranges for a few shuttles to 16, but nothing prevents us to use more shuttles, or to change the spacing between shuttles. If required the tool can be moved between each fracturing stage. The main application of recording the microseismic events is to determine the location of the fracture network by locating the events as a function of time (FIG. 1). Other attributes can be determined, such as the magnitude of the event or the stress drop. Nevertheless none of the information provides any indication about the fracture conductivity once the treatment is completed. This is a very significant issue because production analysis tends to show that the productive fracture surface area is two orders of magnitude less than the one estimated from the fracture treatment, i.e. a significant amount of created fractures does not contribute to the production, either because the fractures were not propped or because the fracture width is too small to be conductive. Any production analysis based on the ESV, the estimated stimulation volume, is therefore in error. Moreover, with a lack of understanding of the created conductive volume, fracturing treatment cannot be optimized. There is a strong need to provide some information on the conductive fracture volume.

According to some embodiments, the information obtained during the process of calibration of the monitoring tool and as well as during the stimulation treatment of an adjacent well is used to carry out a tomography analysis before and after the fracturing treatment to provide some insight of the fracture conductivity once the job is completed. According to some embodiments, this tomographic information is constrained by calibrating it to surface (and/or shallow borehole) seismic information, if this information is available. This technique shows whether the fractures in a given zone are closed, either totally, or partially, if proppant is present in those fractures or shear movement along the fracture face occurred. According to some embodiments, the technique can be further improved by adding one or several downhole sources in an adjacent lateral, allowing waves to be sent during the treatment. According to some embodiments, a sonic tool, such as Schlumberger's SonicScanner is run before the fracturing treatment in the cased lateral, and another run may be performed after the treatment is done, so as to provide further determination of the velocity model and attenuation model.

The tomography can be based on several approaches. According to some embodiments, variation of P- or S-wave velocity, or variation of both waves, can be observed, as it is expected that the zone which has been fractured will suffer a decrease in velocity. Analysis of wave refraction is also a good indicator and has been done in the lab to map hydraulic fractures. See, Groenenboom 2001. According to some embodiments, other measurements are used which can be more sensitive like the attenuation of the waves. Depending on the extent of fracturing, the velocity field may not be significantly affected by the stress changes and the presence of the induced fractures (as it is currently assumed during the stimulation treatment to locate the events), allowing us to use microseismic events in the process of tomography, since we will be able to locate the event and determine the attenuation from various sensors. In cases where only one or two fractures are induced, for example, it is easier to detect the attenuation change than velocity changes. High attenuation relates to fracture width. In particular, it is well-known that S-waves cannot propagate in fluids, thus any open section will not be crossed by S-waves. In practice, the S-wave on a seismic scale will not be attenuated by an open fluid-filled fracture as it will travel through the matrix. However, P-waves will be attenuated due to the change of stiffness between the matrix and the fracture.

FIGS. 1A-B illustrate a configuration for tomographic imaging for hydraulic fracture characterization, according to some embodiments. In FIG. 1A, three lateral wells 102, 104 and 106 have been drilled in subterranean formation 100. The lateral 106 contains the monitoring tool 120 deployed on a wireline 122 that records the microseismic events. The tool 120 as shown contains 11 shuttles separated by a distance of about 100 feet, and each shuttle contains at least a three-component receiver. However, according to some embodiments, other numbers of receivers are used. According to some embodiments, other receiver deployment technologies can be used such as permanent or semi-permanent deployment in well 106.

Prior to fracturing the first lateral well 104 a velocity model is constructed. According to some embodiments, the velocity from the seismic volume is tied to those measured in the wells (e.g., P-wave and S-wave velocity) and produce calibrated 3D velocity volumes. According to some embodiments, 3D volumes of seismic anisotropy parameters will be produced and tied to those measured in a sonic tool. Lateral 104 is perforated and stimulated in three stages 140, 142 and 144. Each time one stage is perforated, the monitoring tool 120 registers the waves emitted by the perforation process to get a new calibration point. Following the perforation of the first stage 140, a first velocity map or attenuation map can be constructed. After perforation of stage 140 is completed, stimulation of stage 140 starts and the tool array 120 records the microseismic events. The fracture area from this stimulation is shown as area 138. Also shown are fracture areas 136 and 134 that result from stimulation of stages 142 and 144 respectively. Once stage 140 is done with both perforation and stimulation, it is isolated using a packer and the same process starts with stage 142, including the calibration process using the perforation process of stage 142. In the case of FIG. 1A, the three stages 140, 142 and 144 of lateral well 104 have been fractured, with a stimulated volume determined from the event locations.

In FIG. 1B, the process is started again for lateral well 102. First, stage 110 is perforated and then stimulated. The process continues for stages 112, 114 and 116. Each time a new stage is fractured, the waves created by the perforation process travel through the zones 134, 136 and 138 that were previously fractured during the stimulation of lateral 104, and are detected by tool 120 in well 106. If sufficient perforation events go through the previously fractured zone 134, 136 and 138, enough data can be obtained to perform either a new wave velocity analysis or a new attenuation analysis to determine the zone or zones which have been the most affected by the fracture network. It can be expected that the amount of change between the tomography before the fracturing treatment and the one after the fracturing treatment is directly a function of the amount of fractures which have been opened. This allows a spatial indicator of fracture conductivity to be determined.

According to some embodiments the certain techniques can be used to improve the accuracy of the determination. For example, as mentioned above, according to some embodiments, a sonic measurement can be run after the fracturing process in the well which has just been fractured to determine the velocity and attenuation changes along the lateral.

According to some embodiments another monitoring well (or other monitoring wells) either in a horizontal or a vertical section could be added.

According to some embodiments, the monitoring tool can be moved during the process, or even be moved from one well to another one.

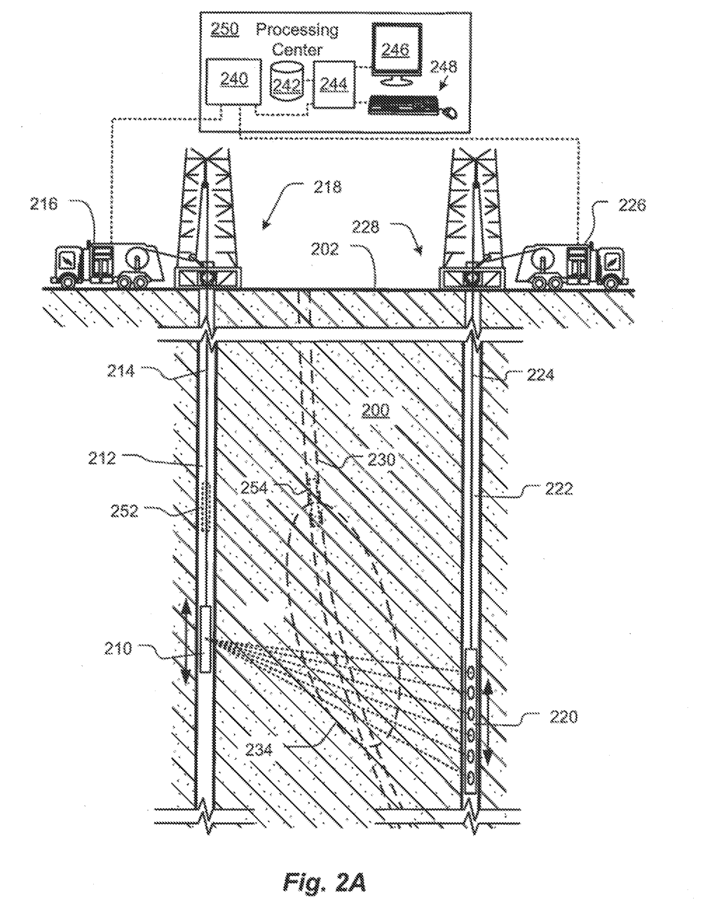

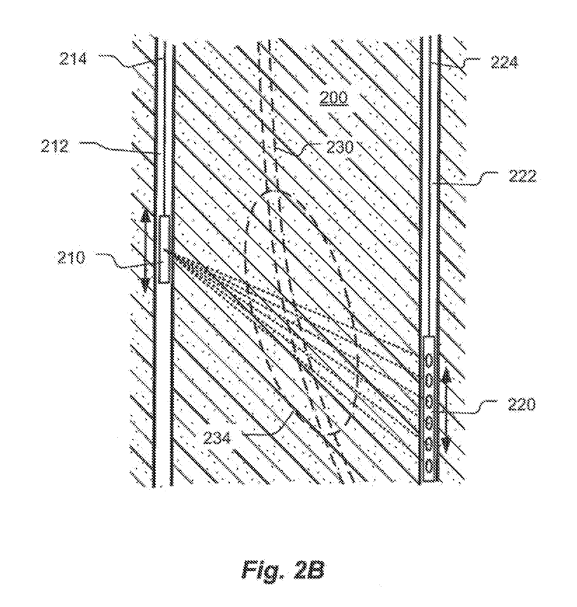

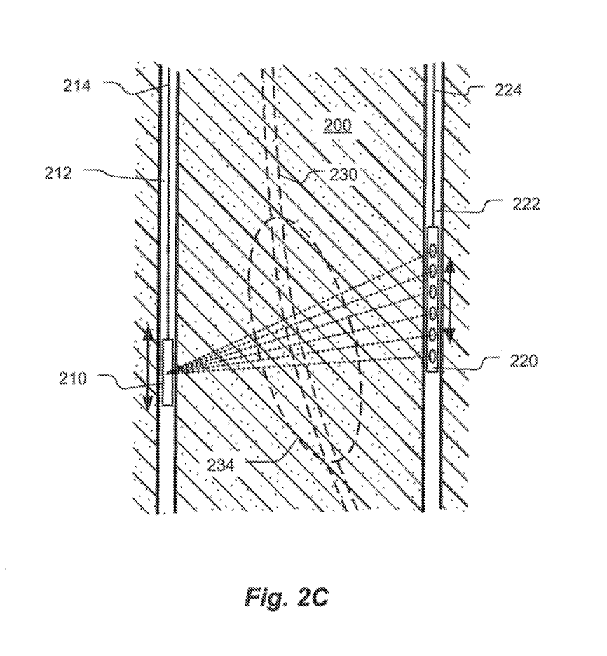

According to some embodiments, rather than (or in addition to) using the wave generated by the perforation process one can use one (or several) downhole seismic source which is moved along the lateral, such as described in further detail with respect to FIGS. 2A-2C.

According to some embodiments, P-wave and PS-wave data from surface seismic can also be used in this determination. These waves can be processed with azimuthal information to provide an estimate of fracture orientation, fracture density and fracture-fluid content. Assuming a suitably high S/N ratio, analysis before and after a fracturing job, will provide an independent quantitative estimate of the fluid-filled fractures.

According to some embodiments, the microseismic events are themselves used in the process, which is very efficient and practical some cases, for example where the wave velocity is little affected by the fracture area but if the attenuation is significantly affected.

Current methods of measuring the effective drainage area of a hydraulic fracture stimulation provide only a measure of fracture wing growth, and do not provide information on what portion of the fracture is actually propped and hence able to drain the reservoir.

According to some embodiments, a pre and post fracture stimulation borehole seismic technique is provided that maps the induced stress in the reservoir created by the propped fracture creation. As such it can provide a measurement of effective fracture radius.

According to some embodiments, the technique utilizes cross-well seismic technology, such as used in Schlumberger's DeepLook-CS tools and service, to acquire the time-lapse stress image. A downhole source is placed in one well and a receiver array is placed in another well. The source is activated or swept creating energy which is transmitted through the formation. The energy is recorded at the receiver array and processed using specialized and proprietary software to yield a tomographic velocity image. This same process is repeated post hydraulic fracture stimulation and the resultant tomographic velocity image is compared with the pre-stimulation or baseline velocity. The resultant difference image is an indication of propped fractures in the reservoir.

FIGS. 2A-C illustrate a configuration for tomographic imaging for hydraulic fracture characterization using downhole seismic sources, according to some embodiments. The technique acquires and processes crosswell seismic information to yield a high resolution time-lapse image of the stress field created by hydraulic fracture stimulation in an oil or natural gas reservoir. The residual stress imaged post fracture stimulation is closely equivalent to the area of the reservoir that remains actively supported by the proppant placed during the stimulation.

Referring to FIG. 2A, three adjacent wells 212, 222 and 230 penetrate a subterranean formation 200. In this example, well 230 will be used for treatment well. The 3-D image is obtained by first acquiring a baseline crosswell seismic tomographic velocity image. This is done by placing a downhole seismic source 210, which can be either piezoelectric or direct coupled, in well 212 that is adjacent to the treatment well 230. Source 210 is deployed in well 212 via wireline 214 and truck 216 at wellhead 218. In well 222, a downhole seismic receiver array 220 is placed to record the seismic events created by the source. Receiver array 220 is deployed in well 222 via wireline 224 and truck 226 at wellhead 228.

Also shown in FIG. 2A is processing center 250 which includes one or more central processing units 244 for carrying out the data processing procedures as described herein, as well as other processing. Processing center 250 also includes a storage system 242, communications and input/output modules 240, a user display 246 and a user input system 248. According to some embodiments, processing center 250 can be included in one or both of the logging trucks 216 and 226, or may be located in a location remote from the wellsites 218 and 228. Although the surface 202 is shown in FIG. 2A as being a land surface, according to some embodiments, the region above the surface 202 can be water as in the case of marine applications.

Seismic source 210 preferably transmits very high bandwidth sound waves (e.g. 30 to 800 Hz) to the receiver array 220, as the source 210 is moved up the wellbore 212. FIG. 2B illustrates the source 210 transmitting while located at a higher position than in FIG. 2A. After source 210 is finished being moved and activated, the receiver array 220 is then moved one array length up the wellbore, as is shown in FIG. 2C. The source 210 again transmits sound waves as it travels up the wellbore 212. This process is replicated until all areas of interest are covered vertically, ensuring that seismic data are fully collected between the wells directly across the reservoir or other zones of interest. In the case of FIGS. 2A-C the expected stimulation zone is area 230 in the vicinity of treatment well 230. Note that the described process differs from conventional passive fracture monitoring which relies on the energy created by the fracture itself being transmitted to a passive receiver array.

Upon completion of the hydraulic fracture stimulation treatment from well 230, a second crosswell seismic image is acquired using the methods described above.

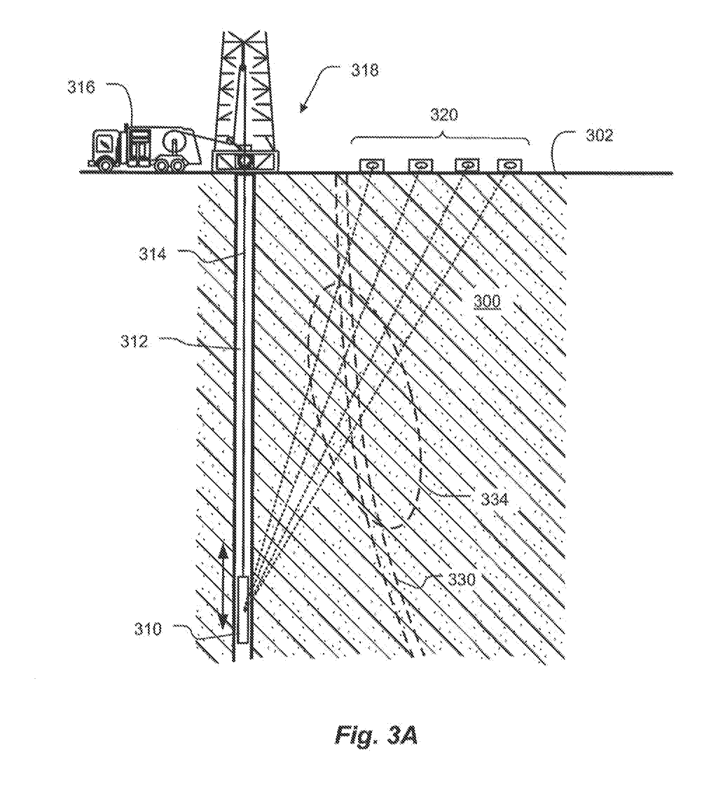

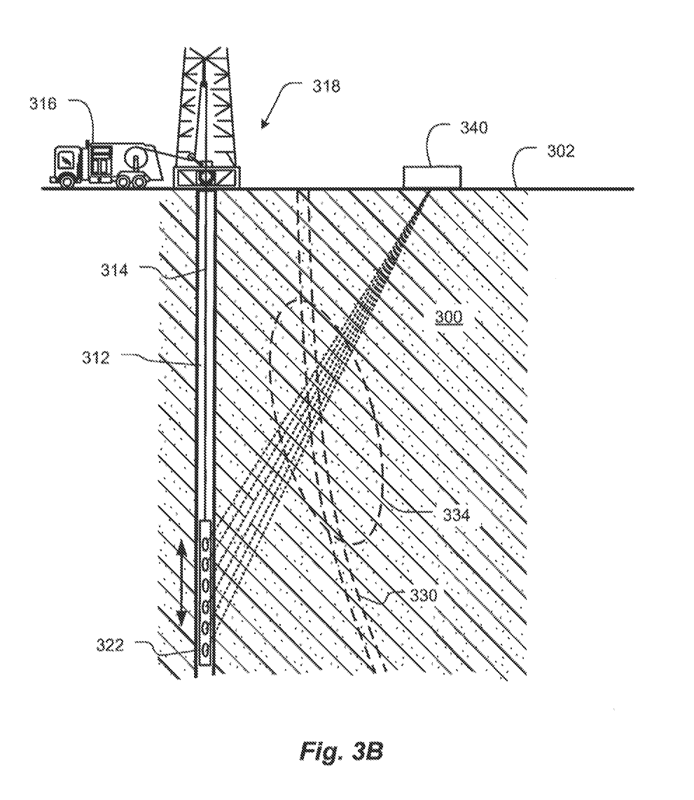

FIGS. 3A-B illustrate a configuration for tomographic imaging for hydraulic fracture characterization using downhole or surface seismic sources, according to some embodiments. FIG. 3A illustrates a borehole-to-surface arrangement for tomographic imaging of hydraulic fracture characterization, according to some embodiments. Two adjacent wells 312 and 330 penetrate a subterranean formation 300. In this example, well 330 will be used for treatment well, and well 312 is the monitoring well. As in previously described examples, the 3-D image can be obtained by first acquiring a baseline seismic tomographic velocity and/or attenuation image prior to the treatment, and upon completion of the hydraulic fracture stimulation treatment from well 330, a second seismic tomographic velocity and/or attenuation image is made. The three dimensional image is made by placing a downhole seismic source 310, which can be either piezoelectric or direct coupled, in well 312 that is adjacent to the treatment well 330. Source 310 is deployed in well 312 via wireline 314 and truck 316 at wellhead 318. On the surface 302, a seismic receiver array 320 is placed to record the seismic events created by the source 310. The source 310 is moved along well 312 so as to provide adequate coverage of the zone of interest 334 in the vicinity of treatment well 330.

FIG. 3B illustrates a surface-to-borehole arrangement for tomographic imaging of hydraulic fracture characterization, according to some embodiments. In the case of FIG. 3B the three dimensional image is made by placing a downhole seismic receiver array 322 in well 312 that is adjacent to the treatment well 330. Receiver array 322 is deployed in well 312 via wireline 314 and truck 316 at wellhead 318. On the surface 302, a seismic source 340 is placed to transmit seismic energy into the subterranean formation 300 and received by array 322. The receiver array 322 is moved along well 312 so as to provide adequate coverage of the zone of interest 334 in the vicinity of treatment well 330. According to some embodiments, the surface source 340 is moved to different positions on the surface so as to provide adequate covers of zone 334 as well. For example, the surface source could be a vibroseis truck.

Although the surface 302 is shown in FIGS. 3A-B as being a land surface, according to some embodiments, the region above the surface 302 can be water as in the case of marine applications. For example, surface 302 is the sea floor and receiver array 320 in FIG. 3A, and/or source 340 can be deployed from a vessel.

According to some embodiments the source and receiver can be in the same well. For example, in the context of FIGS. 3A-B, the source 310 and receiver array 322 can be located in the same well 312, for example by being placed on the same tool string on wireline 314. In the context of FIGS. 2A-C the source 210 and receiver array 220 are placed in the same well such as well 121 or 222.

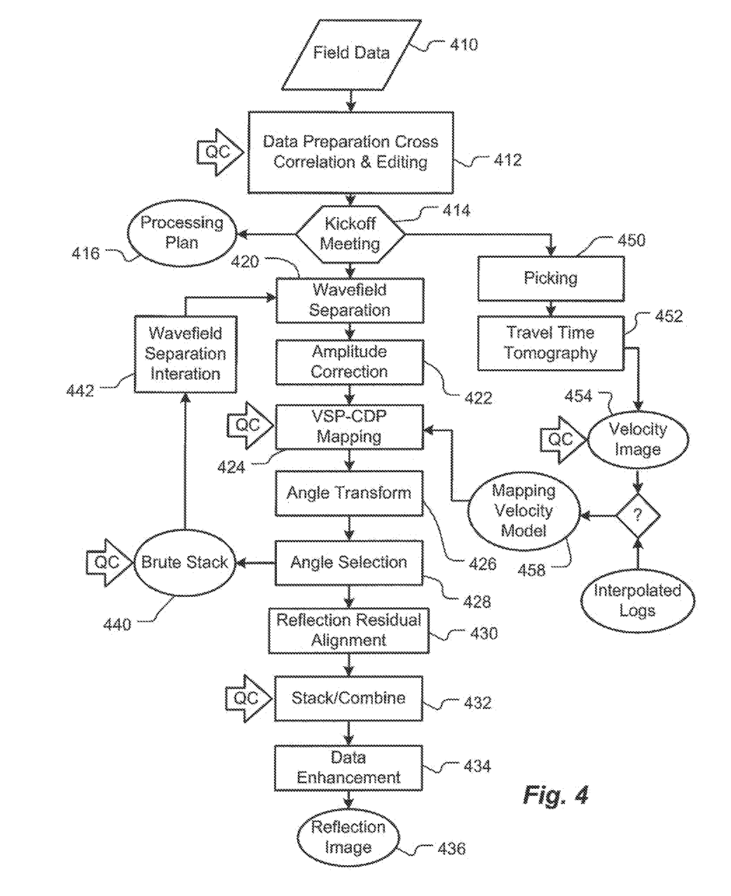

According to some embodiments, the raw data collected in the field through the processes described above is processed to produce a baseline velocity image. FIG. 4 is a flowchart illustrating processing steps involved according to some embodiments.

Data 410 is acquired and in step 412 is being conditioned and quality checked. A processing plan 416 is decided based on the data input, and desired objectives are decided during the kickoff meeting 414. Two parallel routes are followed. Automatic or manual time-picking 450 is used to define arrival times and generate the travel time tomography per se 452, from which a velocity image 454 is derived. If logs can be correlated, a velocity map 458 may be generated. The parallel route starts with wavefield separation 420 and various geophysical processing steps (including amplitude correction 422, VSP-CDP mapping 424, angle transform 426, angle selection 428, brute stack 440, wavefield separation iteration 442, reflection residual alignment 430, stack and combine 432, and data enhancement 434) has an objective to create a reflection image 436 which can be combined with the velocity image 454.

According to some embodiments, a three-dimensional image of the difference in the velocity, attenuation, or other wave attribute, between the baseline and post hydraulic fracture treatment is produced. This difference image is a result of the saturated rock stiffness and of the residual stress post fracture treatment. In particular, the change is mainly due the presence of new fractures, saturated with water, which changes the rock stiffness as well as creating strong discontinuities in stiffness (i.e. matrix vs. fractures). The residual stress is an indication of the fractures that have been created and remain propped versus created and then closed in. The propped or open fractures are the key criteria for evaluating the drainage radius created by the hydraulic fracture stimulation. According to some embodiments, this technique can be used in any well configuration; vertical, slant or horizontal.

Once the analysis is completed, with the availability of either a fluid-filled fracture map, a velocity map, an attenuation map or any other wave attributes, it is staight forward to determine which part of the ESV remains conductive and therefore what is the real stimulated volume hence moving from ESV to RSV.

According to some embodiments, the three-dimensional maps can be derived as a function of time as well, especially if downhole sources in adjacent laterals are used. For example, such a map can be constructed just at shut-in and one a few hours after shut-in. Similar maps can also be generated months after the treatment to see if proppant embedment or fracture clean-up have occurred.

Whereas many alterations and modifications of the present disclosure will no doubt become apparent to a person of ordinary skill in the art after having read the foregoing description, it is to be understood that the particular embodiments shown and described by way of illustration are in no way intended to be considered limiting. Further, the disclosure has been described with reference to particular preferred embodiments, but variations within the spirit and scope of the disclosure will occur to those skilled in the art. It is noted that the foregoing examples have been provided merely for the purpose of explanation and are in no way to be construed as limiting of the present disclosure. While the present disclosure has been described with reference to exemplary embodiments, it is understood that the words, which have been used herein, are words of description and illustration, rather than words of limitation. Changes may be made, within the purview of the appended claims, as presently stated and as amended, without departing from the scope and spirit of the present disclosure in its aspects. Although the present disclosure has been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

What is claimed is:

1. A method of measuring effects of a hydraulic fracturing process on a subterranean formation surrounding a borehole comprising:
deploying and activating one or more sources of acoustic energy and one or more seismic receivers at known locations at least one of which is downhole so as to provide a plurality of ray-paths between source and receiver pairs traversing portions of the subterranean formation in the vicinity of the borehole; and
processing data measured from the one or more sources by the one or more receivers so as to generate three-dimensional data indicating changes in the subterranean formation resulting from the hydraulic fracturing process.

2. A method according to claim 1 wherein the one or more sources of acoustic energy include one or more perforation guns.

3. A method according to claim 1 wherein the plurality of ray-paths include at least three non-coplanar ray-paths.

4. A method according to claim 1 wherein the one or more sources and the one or more seismic receivers are activated prior to the fracturing process and activated again following the fracturing process.

5. A method according to claim 1 wherein the three-dimensional data is a three dimensional image.

6. A method according to claim 5 wherein three dimensional image is a mapped volume indicating fracture network conductivity.

7. A method according to claim 6 wherein the mapped volume is constrained by calibrating the mapped volume to surface seismic data.

8. A method according to claim 6 wherein the mapped volume is constrained by calibrating the mapped volume to shallow borehole seismic data.

9. A method according to claim 5 wherein the processing includes using changes in sonic velocity in generating the image.

10. A method according to claim 9 wherein the processing includes using changes in P and S wave velocity in generating the image.

11. A method according to claim 9 wherein the processing includes using P to S wave conversions in generating the image.

12. A method according to claim 5 wherein the processing includes using change in attenuation in generating the image.

13. A method according to claim 5 wherein the processing includes using change in frequency content in generating the image.

14. A method according to claim 1 wherein the one or more sources of acoustic energy includes a downhole seismic source.

15. A method according to claim 1 wherein the downhole seismic source is a microseismic source deployed in a second borehole traversing the subterranean formation.

16. A method according claim 1 wherein the one or more seismic receivers are microseismic receivers deployed in a second borehole traversing the subterranean formation.

17. A method according to claim 1 wherein at least one of the one or more seismic receivers and one or more sources are deployed in the borehole through which the hydraulic fracturing process is carried out.

18. A method according to claim 1 wherein the one or more seismic receivers are permanently or semi-permanently deployed in a borehole.

19. A method according to claim 1 wherein the processing includes use of surface seismic data relating to the subterranean formation in generating the three dimensional data.

20. A method according to claim 1 wherein the processing includes use of sonic logging data relating to the subterranean formation in generating the three-dimensional data.

21. A method according to claim 1 wherein the three-dimensional data indicates locations of proppant within fractures induced by the hydraulic fracturing process.

22. A method according to claim 1 wherein the three-dimensional data indicates whether shear movement has occurred along faces of fractures induced by the hydraulic fracturing process.

23. A method according to claim 1 wherein the processing includes updating a velocity model for the subterranean formation.

24. A method according to claim 1 wherein each of the one or more seismic receivers includes a three component sensor.

25. A system for measuring the effects of a hydraulic fracturing process on a subterranean formation surrounding a borehole comprising:
a source of acoustic energy deployable downhole at a known location, the source adapted to transmit acoustic energy into the subterranean formation;
one or more seismic receivers adapted and deployable so as to receive acoustic energy having traversed portions of the subterranean formation expected to be effected by the hydraulic fracturing process;
a processing system adapted and programmed to process data measured from the source by the one or more receivers so as to generate three-dimensional data indicating changes in the subterranean formation resulting from the hydraulic fracturing process.

26. A system according to claim 25 wherein the one or more seismic receivers are further adapted to be deployable downhole.

27. A system according to claim 25 wherein the source is a perforation gun.

28. A system according to claim 25 wherein the source is a downhole seismic source.

29. A system according to claim 28 wherein the downhole seismic source is either piezoelectric or direct coupled.

30. A system according to claim 28 wherein the source is a downhole microseismic source.

31. A system according to claim 25 wherein the three-dimensional data is a three dimensional mapped volume image indicating fracture network conductivity.

32. A system according to claim 25 further comprising a sonic logging tool adapted to make sonic measurements of the subterranean formation for use in generating the three-dimensional data.

33. A system for measuring the effects of a hydraulic fracturing process on a subterranean formation surrounding a borehole comprising:
a source of acoustic energy deployable at a known location, the source adapted to transmit acoustic energy into the subterranean formation;
one or more seismic receivers adapted and deployable downhole so as to receive acoustic energy having traversed portions of the subterranean formation expected to be effected by the hydraulic fracturing process;
a processing system adapted and programmed to process data measured from the source by the one or more receivers so as to generate three-dimensional data indicating changes in the subterranean formation resulting from the hydraulic fracturing process.

34. A system according to claim 33 wherein the acoustic source is adapted to be deployable downhole.

35. A system according to claim 33 wherein the one or more seismic receivers are permanently or semi-permanently deployed in a borehole.

36. A system according to claim 33 wherein each of the one or more seismic receivers includes a three-component sensor.

37. A method for analyzing fractures in a drainage radius, comprising:
performing a baseline survey of a drainage radius comprising a plurality of crosswell seismic measurements;
applying a fracture stimulation treatment to the drainage radius;
performing a post fracture treatment survey of the drainage radius comprising a plurality of crosswell seismic measurements; and
generating a time-lapse difference image result of residual stress indicating whether fractures from the treatment have been created and remain propped, or created and then closed in.

38. The method according to claim 37, wherein the plurality of crosswell seismic measurements are made by employing a seismic source disposed in a first well adjacent to a treatment well and a seismic receiver array disposed in a second well adjacent to the treatment well.

39. The method according to claim 37, further comprising generating a velocity model for event placement in the reservoir.

40. The method according to claim 37, further comprising cross correlating the results of the baseline survey and the post fracture treatment survey and editing the results of the baseline survey and the post fracture treatment survey.

41. The method according to claim 40, further comprising generating a velocity image from the cross-correlated and edited results by applying a picking scheme and applying travel time tomography scheme.

42. The method according to claim 41, further comprising mapping the velocity image.

43. The method according to claim 40, further comprising separating wavefields and applying amplitude correction to the results of the baseline survey and the post fracture treatment survey.

44. The method according to claim 43, further comprising applying VSP-CDP mapping to the results of the baseline and the post fracture treatment surveys.

45. The method according to claim 43, further comprising applying an angle transform to the results of the baseline and the post fracture treatment surveys.

46. The method according to claim 43, further comprising applying an angle selection to the results of the baseline and the post fracture treatment surveys.

47. The method according to claim 43, further comprising applying a reflection residual alignment to the results of the baseline and the post fracture treatment surveys.

48. The method according to claim 43, further comprising stacking and combining the results of the baseline and the post fracture treatment surveys.

49. The method according to claim 43, further comprising applying a data enhancement scheme to the results of the baseline and the post fracture treatment surveys.

50. The method according to claim 43, further comprising generating a reflection image indicative of residual stress remaining after the hydraulic fracture treatment.

51. A system for measuring the effects of a hydraulic fracturing process on a subterranean formation surrounding a borehole comprising:
a source of acoustic energy deployable at a known location in the borehole, the source adapted to transmit acoustic energy into the subterranean formation;
one or more seismic receivers adapted and deployable at known locations in the borehole, so as to receive acoustic energy having traversed portions of the subterranean formation expected to be effected by the hydraulic fracturing process;
a processing system adapted and programmed to process data measured from the source by the one or more receivers so as to generate three-dimensional data indicating changes in the subterranean formation resulting from the hydraulic fracturing process.

52. A system according to claim 51 wherein the source is a downhole seismic source.

53. A system according to claim 52 wherein the downhole seismic source is either piezoelectric or direct coupled.

54. A system according to claim 51 wherein the three-dimensional data is a three dimensional mapped volume image indicating fracture network conductivity.
